(19) United States
(12) Patent Application Publication
(10) Pub. No.: US 2008/0023314 A1
(43) Pub. Date: Jan. 31, 2008

(54) Push-button switch

(76) Inventor: Wei-Hua Tseng, Taichung County (TW)

Correspondence Address: BROWDY AND NEIMARK, P.L.L.C.;624 NINTH STREET, NW, SUITE 300, WASHINGTON, DC, 20001-5303, US

(21) Appl. No.: 11/492,958

(22) Filed: Jul. 26, 2006

(51) Int. Cl. H01H 13/72

(52) U.S. Cl. 200/5 B

(57) ABSTRACT

A push-button switch includes: a shell composes of a top plate and a button plate. The button plate is made of insulated material. At least two speed-button units mount on the top plate. Each speed-button unit has a couple of conductor set at the button and each conductor set includes a conductor and a connector. The press-arm can press the conductors to move downward and touch the connectors and make the circuit connected when the corresponding speed-button unit is pushed. A lock device mounts in the shell for keeping the button in lock mode position when the button was pushed. A release-button mounts on the top plate and can be pushed to release all buttons from lock mode. A signal-conductor unit that mounts under the signal-button includes a conductor and a connector. The conductor unit forms a signal circuit when the signal-button was pushed.

### BACKGROUND OF THE INVENTION

1. Field of the Invention

The present invention relates to a push-button switch and more particularly to a push-button switch that can generate a detective signal to extend the action time of electric equipment.

2. Description of the Related Art

In prior art, push-button switches are well know and popular using on a smoke exhauster, an electric fan and so on. The push-button switches become standard components for a smoke exhauster or an electric fan manufacturer because of the stable structure, the accurate action and also qualify for many safeties verifies. Due to the acceptability in the market, the molds and the cost of manufacture, the standards of the push-button switch can not be changed indiscreetly. But, the require for more functions of electric equipment from the customer are increasing day by day. For example, the customer may hope the smoke exhauster can keep on running for 5 or 10 more minutes after the power turned off then shut down automatically. This function can not be provided in prior art push-button switch. There are some other ways to provide this function. For example, the manufacturer may add other time-delay switch or uses other type of switch to achieve this function. But, this change will increase much design and manufacture problems and also increase the cost.

### SUMMARY OF THE INVENTION

The object of the present invention is to provide a push-button switch in traditional look and standard size but more functions.

To achieve this object of the present invention, the technical method in present invention is adding a signal-conductor unit in traditional push-button switch. By the way, the signal-conductor can generate a signal when the release-button is pushed and the anticipation delayed-action time circuit can be controlled and turned on or off by detecting the length of signal. In order to provide a better function, the better technical method in present invention is providing two conductor units under the speed-button. The conductor units will form a circuit when the corresponding signal-button was pushed. By the way, one of the conductor units can connect with electrical equipment (ex. Motor) to control actions and another conductor unit connects with a control circuit for generating a control signal to cancel aforesaid delayed-action time circuit and also prevent the overload problem.

### BRIEF DESCRIPTION OF THE DRAWINGS

FIG. 1 is a perspective view of the first embodiment of the present invention;

FIG. 2 is a front view of the first embodiment of the present invention;

FIG. 3 is a back view of the first embodiment of present invention;

FIG. 4 is a perspective view of the conductor unit in the first embodiment of present invention;

FIG. 5 is a chart of the switch system in the first embodiment of present.

FIG. 6 is a perspective view of the second embodiment of present invention.

### DETAILED DESCRIPTION OF THE INVENTION

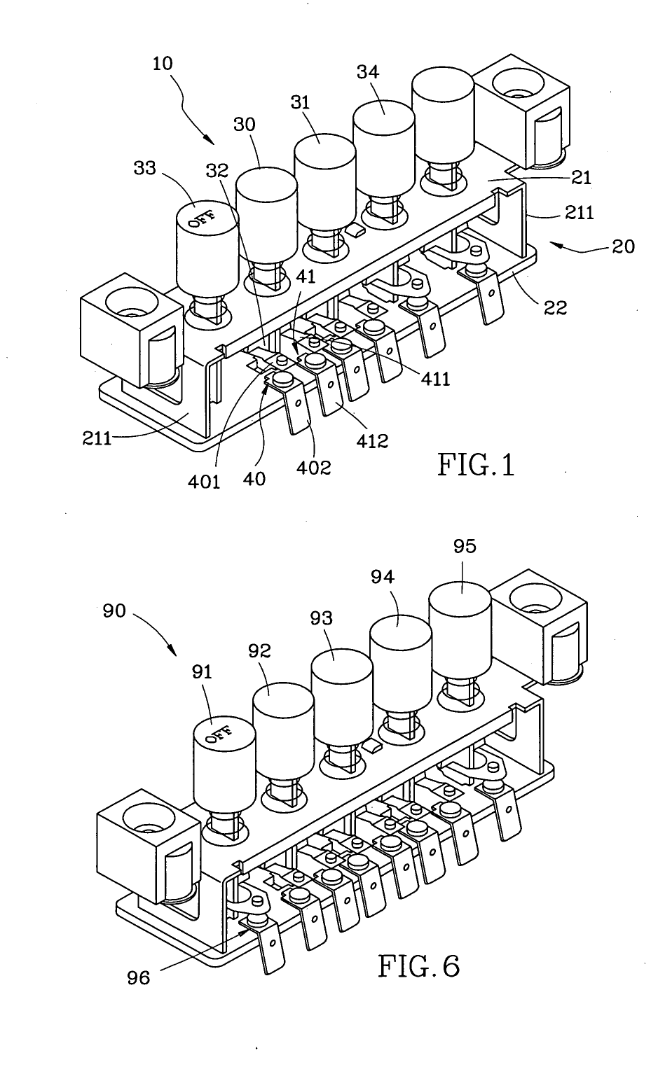

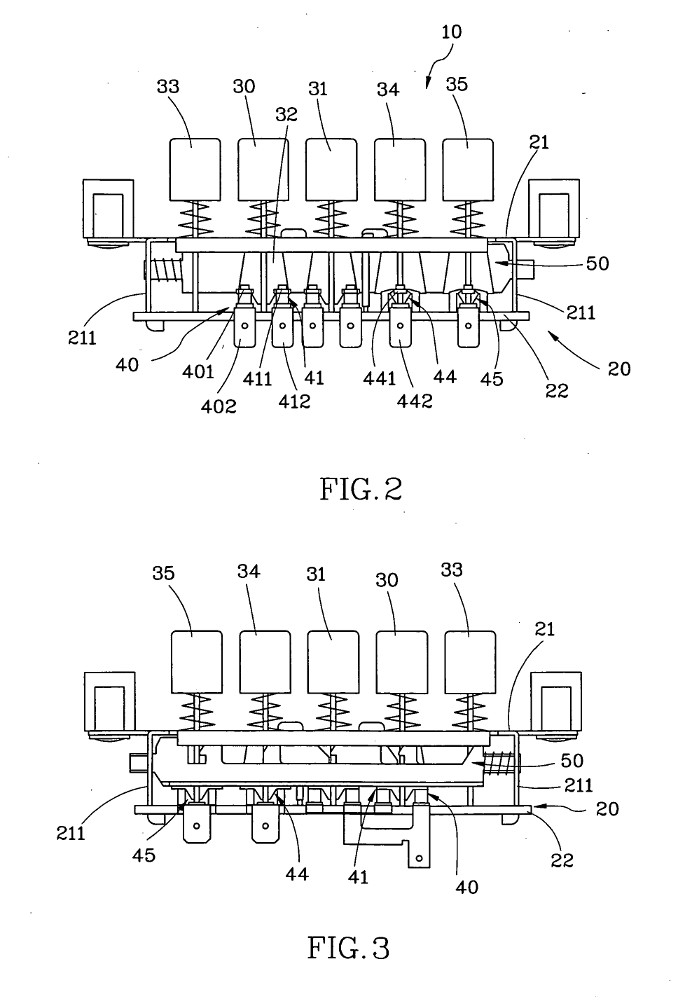

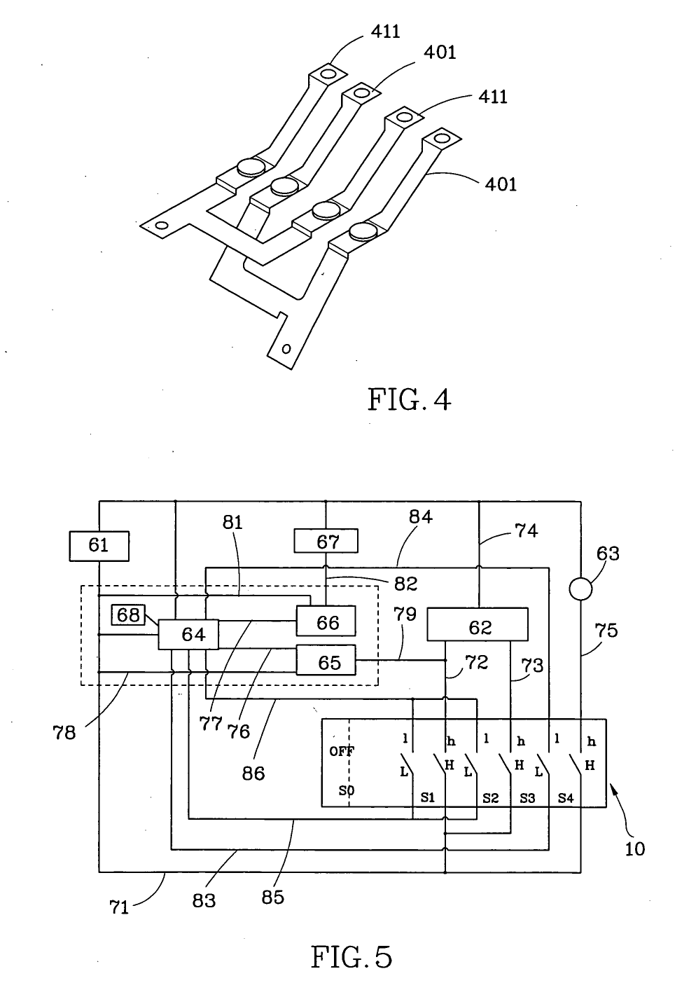

Referring to FIG. 1 to FIG. 4, a push-button switch 10 of the first embodiment of present invention includes:

A shell 20 composes of a top plate 21 and a button plate 22. The top plate 21 with two arm portion 211 is made of metal plate by pressing. The button plate 22 is made of insulated material and fixed on the end of two arm portions 211 (this is a prior art structure).

Two speed-button units 30 31 mount on the top plate 21 and each unit has an insulated press-arm 32 at the button end (this is a prior art structure). These two units ( can move up or down by way of push. Each speed-button unit has a couple of conductor sets 40 41 at the button and each of the conductor sets includes a conductor 401 411 and a connector 402 412. This is a broken circuit in normal condition. The press-arm 32 can press the conductors 401 411 to move downward and touch the connectors 402 412 and make the circuit connected when the corresponding speed-button unit is pushed.

A lock device 50 mounts in the shell 20 for keeping the button in lock mode position when the button was pushed (this is a prior art structure).

A release-button 33 mounts on the top plate 21 and can be pushed to release all buttons from lock mode (this is a prior art structure).

A signal-button 34 mounts on the top plate 21 and can be pushed to release all buttons from lock mode (this is a prior art structure).

A signal-conductor unit 44 that mounts under the signal-button 34 includes a conductor 441 and a connector 442. The conductor 441 stays a way from the connector 442 at normal condition. The conductor will touch the connector to form a signal circuit and generate a signal when the signal-button 34 was pushed.

A lighting-button 35 mounts on the top plate 21.

A conductor unit 45 mounts under the lighting-button 35.

The push-button switch 10 of present invention can use on a smoke exhauster, an electric fan or other electric equipments that need to change operation speed. As shows in FIG. 5, this is a chart of switch system of present invention which using on a smoke exhauster. In the FIG, the mark 10 means a push-button, S0 means a release-button 33, S1 means a high-speed button 30 and corresponding conductor unit 40, S2 means a low-speed button 31 and corresponding conductor unit 41, S3 means a signal-button 34 and corresponding conductor unit 44, S4 means a light-button 35 and corresponding conductor unit 45. The mark 61 means an AC power source and the mark 62 means a motor. The mark 63 means a light and the mark 64 means a microprocessor with a delayed-action time function. The marks 65 66 mean an electric-control switch (a relay) and the mark 67 means a heater (in this embodiment, the heater is a halogen lamp). The mark 68 means a LED. The AC power source 61 connects with the right side conductor 401 of the S1, S2 and the conductor of S4 by wire 71 as a H shows in the FIG The wire 72 connects with the high-speed circuit of the motor 62 and the right side connector 402 of the S1 as a h shows in FIG The wire 73 connects with the low-speed circuit of the motor 62 and the right side connector 402 of the S2 as a h shows in FIG The motor 62 connects with the power source 61 by wire 74. The light 63 series connects with the power source 61 and connector of S4 as a h shows in FIG by wire 75. The aforesaid circuit is a prior art of smoke exhauster. The microprocessor 64 that has a commutator (not shows in FIG) connects with the power source 61 and transforms AC power into DC power for two electric-control switch 65 66 and also control the on/off of these electric-control switches. The wire 78 connects with the power source 61 and the electric-control switch 65. The wire 79 connects with the electric-control switch 65 and the high-speed circuit of the motor 62 to form another power supply circuit. The heater 67 connects with the electric-control switch 66 and the AC power source 61 by wire 81 and wire 82 to form a power supply circuit. The signal-button S3 connects with the microprocessor by wire 83 and wire 84 to form a light current detective circuit. The wire 85 connects with S1 and the left side conductor 411 of the S2 as a L shows in FIG. The wire 86 connects with S1 and the left side conductor 411 of the S2 as a I shows in FIG Both of the wire 85 and wire 86 connect with the microprocessor 64 to form another detective circuit.

The motor will start to exhaust smoke when user pushes the speed-button S1 or S2 and the light will turn on when user pushes the light-button S4. All buttons will be released when the release-button S0 is pushed. These operation methods are the same as prior art. There is a signal-button S3 of this embodiment of present invention. The smoke exhauster will work in delayed-action time when the signal-button S3 is pushed. The microprocessor in this embodiment has a calculating function to count the delayed-action time. There are many modules that set up in the microprocessor for providing different choices. There are three modules in this embodiment. The first module is an exhausting process for exhaust smoke only. This module only sets the exhausting process time (ex. 10 minutes) and turn off the smoke exhauster when the time is up. The second module is a deodorization and oil-free process. In This module, the heater 67 will be turned on for setting an anticipation time (ex. 10 minutes) first and then turn off. After that, start the motor 62 within an anticipation time (ex. 5 minutes) to erase the odor that produces from oil-free process. The third module will run oil-free process in an anticipation time (ex. 10 minutes) after exhaust smoke within an anticipation time (ex. 5 minutes) and then process the exhausting smoke action and erasing odor action in anticipation time (ex. 5 minutes). The duration time of pushing signal-button S3 will determines which module will be processed in this embodiment. For convenience, the microprocessor 64 connects with LED 68 that shows in different color (ex. Red, yellow, green) or different flash frequency like quick-flash, slow-flash, or long-flash with different modules. The duration time of pushing signal-button S3 will be took as a release-signal to cancel all of the work in delayed-action time if the duration time not reaches the anticipation time (ex. 1 second). The user can keep pushing the signal-button S3 until the desired signal lamp shows out. Then, the smoke exhauster will work in delayed-action time and turn off automatically after all works done. The user can push the signal-button S3 again if the user wants to break off the delayed-action time work and cancel all works. This is easy to operate. If the user wants to reuse the smoke exhauster during the delayed-action time, pushing the speed-button S1 or S2 can make the change. The other detective circuit of speed-button S1 or S2 will generate a signal to the microprocessor 64 to cancel the delayed-action time works immediately. This function will be as the same as a reset-button. This action can prevent to turn on the motor and the heater at the same time and also prevent the motor overload.

Referring to FIG. 6, this is a switch 90 of the second embodiment of present invention. The structures in this embodiment and in the first embodiment are almost the same. There are five buttons therein and the button 91 is a release-button. The button 92 is a high-speed button and the button 93 is a middle-speed button. The button 94 is a low-speed button and the button 95 is a light button. There is no signal-button in the embodiment but a signal-conductor unit 96 mounted under the release-button 91. There are not two speed-buttons but three speed-buttons in the embodiment. The connect method of the wires of this embodiment and the first embodiment are almost the same. This embodiment only changes the high or low speed choices of the motor into high, middle and low speed choices.

As aforesaid, the push-button switch of present invention can provide more functions to match the desired of custom but not change the traditional scale. Meanwhile, present invention does have the business benefit by using the traditional mold and the manufacture process.

What is claimed is:

1. A push-button switch, comprising:
a shell composes of a top plate and a button plate; the button plate is made of insulated material;
at least two speed-button units are mounted on the top plate and each unit has an insulated press-arm at the button end; these two units can move up or down by way of push; each speed-button unit has a couple of conductor set at the button and each conductor set includes a conductor and a connector; this is a broken circuit in normal condition; the press-arm can press the conductors to move downward and touch the connectors and make the circuit connected when the corresponding speed-button unit is pushed;
a lock device mounts in the shell for keeping the button in lock mode position when the button was pushed;
a release-button mounts on the top plate and can be pushed for releasing all buttons from lock mode;
a signal-conductor unit that mounts under the release-button includes a conductor and a connector; the conductor stays a way from the connector at normal condition and the conductor will touch the connector to form a signal circuit and generate a signal when the signal-button was pushed.

2. The push-button switch as claimed in claim 1, wherein the signal-conductor unit connects with the microprocessor and the microprocessor can detect the signal and set the delayed-action time work automatically or cancel process by connecting the circuit and the connecting duration.

3. The push-button switch as claimed in claim 2, wherein each couple of the conductor units under the speed-button forms a power supply circuit and a signal circuit and each of the signal circuits connects with the microprocessor for canceling delayed-action time work.

4. The push-button switch as claimed in claim 3, wherein the switches mount on a smoke exhauster and the power supply circuit of the speed-button connect with the motor of fan in the smoke exhauster; the microprocessor connects with the motor of fan to form a power supply circuit by an electric-control switch.

5. The push-button switch as claimed in claim 4, wherein the smoke exhauster has a heater more over; the microprocessor forms a power supply circuit by another electric-control switch to supply power to the heater.

6. The push-button switch as claimed in claim 1, wherein the switch has a light-button more over; the conductor unit under the light-button can supply electrical power for the light.

7. The push-button switch as claimed in claim 1, wherein the switch has a signal-button that mounts on the top plate more over; the signal-button can be pushed for releasing all buttons from lock mode position; the signal-conductor set not under the release-button but the signal-button.

8. The push-button switch as claimed in claim 7, wherein the signal-conductor unit connects with the microprocessor and the microprocessor can detect the signal and set the delayed-action time work automatically or cancel process by connecting the circuit and the connecting duration.

9. The push-button switch as claimed in claim 8, wherein each couple of the conductor units under the speed-button forms a power supply circuit and a signal circuit and each of the signal circuits connects with the microprocessor for canceling delayed-action time work.

10. The push-button switch as claimed in claim 9, wherein the switches mount on a smoke exhauster and the power supply circuit of the speed-button connect with the motor of fan in the smoke exhauster; the microprocessor connects with the motor of fan to form a power supply circuit by an electric-control switch.

11. The push-button switch as claimed in claim 10, wherein the smoke exhauster has a heater more over; the microprocessor forms a power supply circuit by another electric-control switch to supply power to the heater.

12. The push-button switch as claimed in claim 7, wherein the switch has a light-button more over; the conductor unit under the light-button can supply electrical power for the light.
